(19) United States
(12) Patent Application Publication
(10) Pub. No.: US 2009/0259535 A1
(43) Pub. Date: Oct. 15, 2009

(54) COUPON CLIPPER

(75) Inventor: David Chow, Cumming, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 12/101,937

(22) Filed: Apr. 11, 2008

(51) Int. Cl. G06Q 30/00

(52) U.S. Cl. 705/14

(57) ABSTRACT

A coupon clipping interface and related methods and apparatus are provided. The coupon clipper's features include displaying at least one online coupon, receiving selection of at least one selected coupon selected from the at least one online coupon, providing the at least one selected coupon for subsequent redemption in response to user selection of a redemption user interface feature associated with the at least one selected coupon, storing the at least one selected coupon as at least one clipped coupon in response to user selection of a clip coupon interface component associated with the at least one selected coupon, wherein the at least one clipped coupon is available for subsequent retrieval via a clipped coupons interface, and displaying a summary representation of the at least one clipped coupon. The coupon clipper's features may also include displaying the at least one clipped coupon in response to receiving selection of an interface feature associated with the summary representation of the at least one clipped coupon, and providing the at least one clipped coupon for subsequent redemption in response to user selection of a redemption user interface feature.

### BACKGROUND

1. Field

The present application relates generally to electronic commerce, and more specifically to the use of electronic coupons on the World Wide Web.

2. Related Art

The use of coupons in electronic commerce and on Web sites is known in the art. Online coupons may be displayed to users and redeemed by users for discounts when purchasing produces either online or offline, e.g., for purchases made on Web sites or in physical stores.

### BRIEF DESCRIPTION OF THE DRAWINGS

The present application can be best understood by reference to the following description taken in conjunction with the accompanying drawing figures, in which like parts may be referred to by like numerals:

FIGS. 1-4 illustrate coupon clipping interfaces in accordance with embodiments of the invention.

FIG. 5 illustrates a clipped coupon interface in accordance with embodiments of the invention.

FIG. 6 illustrates a system for clipping online coupons in accordance with embodiments of the invention.

FIG. 7 illustrates a process of clipping online coupons in accordance with embodiments of the invention.

FIG. 8 illustrates a process of displaying clipped coupons in accordance with embodiments of the invention.

FIG. 9 illustrates a typical computing system that may be employed to implement processing functionality in embodiments of the invention.

### DETAILED DESCRIPTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

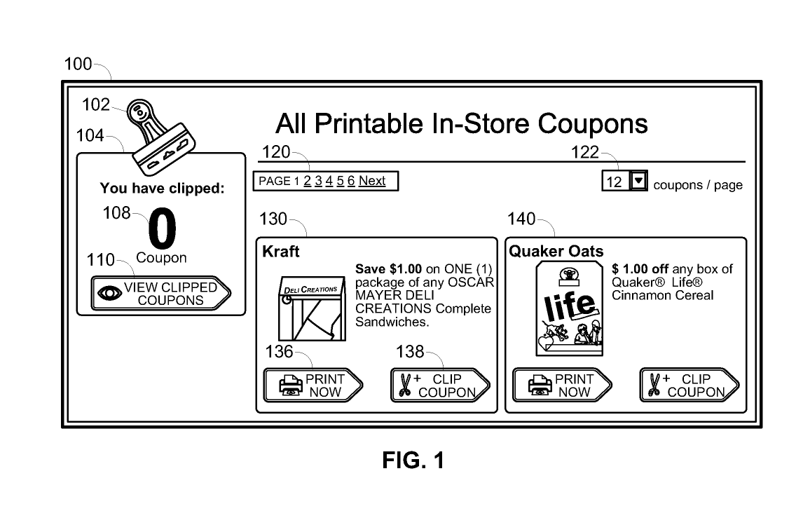

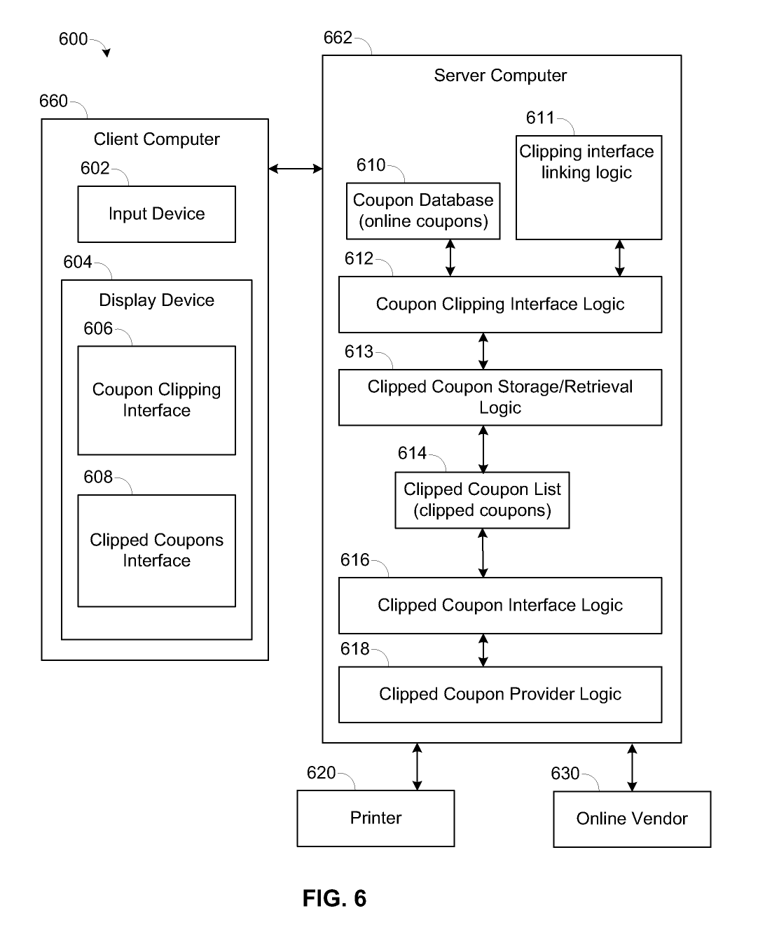

FIGS. 1-4 illustrate coupon clipping interfaces in accordance with embodiments of the invention. FIG. 1 illustrates a coupon clipping interface 100, which may be displayed in, for example, a web browser executing on a client computer (not shown). The web browser may receive coupon clipping interface logic (see FIG. 6; not shown in FIG. 1) from a server via a network, e.g., the Internet, and display the coupon clipping interface 100, which is a graphical user interface generated by the coupon clipping interface logic in one example. The coupon clipping interface 100 includes a clipping icon 102 that identifies associated a clipped coupon summary 104 as a part of the coupon clipper interface 100. The coupon clipping interface 100 displays at least one online coupon 130, and provides a Print Now button 136 and a Clip Coupon button 138 associated with (i.e., displayed near or within) the coupon 130. The term “online” is not meant to imply that the coupon must be in any particular state, but instead identifies the coupon as an object that represents a coupon in a coupon clipping interface 100, which may be online, e.g., executed by a computer, interacting with a user, and, in some examples, communicating with a server via a network. Each displayed online coupon may include a vendor name, e.g., “Company X”, a graphical image such as an image of a product to which the coupon applies, and descriptive text, e.g., “Save $1.00 on one widget.” Multiple coupons 130, 140 may be displayed in the interface 100, and in some examples, the number of coupons to be displayed per page can be specified by a Coupons Per Page selector 122. If the number of available online coupons exceeds the number of coupons per page, then the online coupons will be displayed on multiple pages, and a user may select a particular page to view using a page selector interface 120. In one example, online coupons are time-limited, and expire after a specified time period has elapsed subsequent to their creation.

In one example, the Clip Coupon button 138 may be selected, e.g., clicked on, using a mouse input device, to cause an online coupon 130 to be clipped, i.e., added to a list of clipped coupons (not shown). In one example, when a user clips an online coupon, the coupon is as part of a list of clipped coupons for that user in a storage area (e.g., memory, disk, or other storage medium) associated with the user of the web browser.

Because the list of clipped coupons is associated with the user of the web browser, the list may contain different coupons for each user. Furthermore the list of clipped coupons may be cleared when the web browser is closed, or may be stored in persistent storage such as a database, so that the list retains its contents across browsing sessions and browser processes. The list of clipped coupons retains its content (i.e., online coupons) when the web browser loads and displays different pages, e.g., pages that do not show online coupons 130, 140. In some examples, the different pages may display the coupon icon 102 and clipped coupon summary 104, e.g., by including links to a web server that provides the clipped coupon summary 104, where the link to the web server is provided by, for example, a component of the coupon clipper interface 100. The clipped coupon summary 104 also includes a coupon count 108, which is the number of coupons that have been clipped by the user of the web browser. The coupon count 108 is initially zero if no coupons are initially in the user's list of online coupons, and increases by one each time a coupon is successfully added to the user's list of online coupons. Coupons may be redeemed, as described below, or may expire. Therefore the coupon count 108 is, in one example, the number of coupons that have been clipped by the user or otherwise added to the user's list of clipped coupons, minus the number of clipped coupons that have expired, been redeemed, or otherwise become invalid.

In other examples, only one of the buttons 136, 138 is be present in a displayed online coupon 130, or the buttons 136, 138 may be implemented as different types of user interface components, e.g., text links or drag-and-drop-compatible objects.

The coupon clipping interface 100 further allows a user of the web browser to select the Print Now 136 button to print a coupon for subsequent use as a physical coupon, e.g., to be redeemed for a discount on a purchased item. Coupons may be redeemed by, for example, taking a printed coupon to a store. In other examples, the coupon may be displayed on a user's cell phone so that a scanner may scan it, or the coupon may be provided to an shopping cart of an online vendor. In other examples, there may be an embedded device on a shopping cart for redeeming coupons, and the online vendor may transfer the coupon to the shopping cart via a BlueTooth™ network. In another example, a 9-digit code may be displayed on a mobile device to represent a coupon, and that code would be entered at the point of sale to receive a discount.

In one example, a button may be provided for transmitting the coupon to an online store web site. In other examples, a portion of the coupon clipping interface 100 associated with the clipped coupon summary, referred to herein as a clipped coupon provider, may make the clipped coupons available to online vendors, such as electronic commerce web sites. In one example, when an online coupon 130 is redeemed, by, for example, printing it or transmitting it to an online vendor as part of a purchase transaction, the online coupon 130 becomes invalid and is deleted from the list of clipped coupons, if it has been clipped, or from the list of displayed, unclipped coupons 130 if it has not been clipped.

In some examples, the clipped coupon summary 104 may be displayed on arbitrary web pages, without the displayed coupons 130, 140. In that case the user may click on or select the clipped coupon summary 104 to cause display of the clipped coupons. In other examples, arbitrary web pages may display one or more coupons 130 along with other content, and the user may add the coupons 130 to the user's list of clipped coupons by selecting a Clip Coupon button 138 associated with the coupon 130, or by dragging and dropping the coupon 130 to an area near the clipped coupon summary or clip icon 102.

Examples of the use of the clipped coupon summary 104 (also referred to herein as the “clipper”) on web pages are as follows. A network of web sites, such as an information provider or portal, may make the clipper 104 available on relevant sites. In one example, a user may be viewing a food-related web site that lists recipes, and may see the Super Bowl on television. The user may then wish to make Super Bowl dip from a recipe on the web site. The user may have a list of clipped coupons, and the food-related web site may display coupons related to food next to the recipe. If the recipe calls for Philadelphia Cream Cheese, a “Coupon Available-Clip Here” indicator may appear near the recipe entry for cream cheese. If a user clicks on the indicator, then the coupon would be displayed with an option to clip the coupon. Other types of coupons are possible, such as percentage rebates at stores.

In one example, the clipped coupon summary may be represented as a badge, which is an icon that, if selected, causes a web link to be followed to open the clipped coupon summary 104 and/or the online coupons 130, 140 (up to any number of coupons, spanning multiple pages if necessary) in a user's browser. The badge may be implemented using Adobe® Flash® code, e.g., an SWF, represented as, for example a line of Hypertext Markup Language (HTML) code. A web site may embed that code into a web page. On a backend server, the code contacts a central coupon database, and verifies that the coupon identifiers in the user's list of clipped coupons still refer to valid coupons. If so, no action is taken. If a coupon is no longer valid, it is removed from the list of clipped coupons. If a client web site wishes to use a Clip Here button (i.e., the badge) to access the coupon clipper features hosted by a clipper provider, then the appropriate snippet of code would be added to the web site's pages. The coupons recognized by the client web site would be loaded into the clipper provider's coupon database, and the clipper provider should be granted legal rights to the client company's images and offers.

In one example, a search feature for searching the online coupons (either all coupons known, or all coupons clipped, or a combination or subset thereof) for coupons containing a user-specified text string may be provided. The search feature would simply search the text description and vendor name, and price (and any other fields) of the coupons and display any online coupons that have text matching the search string.

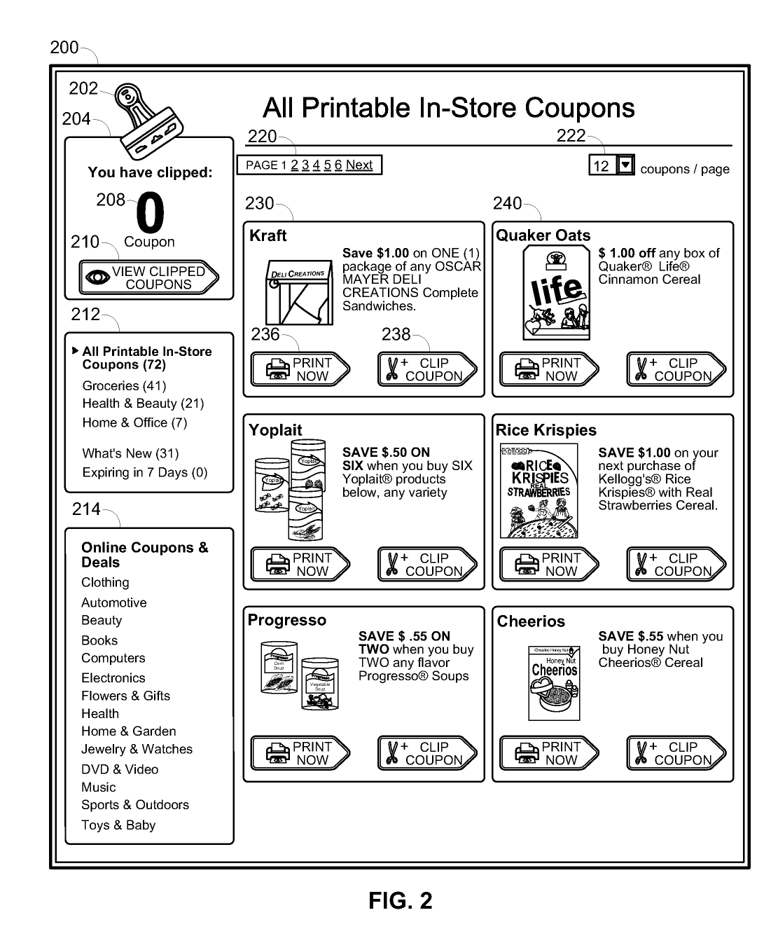

FIG. 2 illustrates a coupon clipping interface in accordance with embodiments of the invention. The coupon clipping interface 200 of FIG. 2 is an extension of the interface 100 of FIG. 1. The interface 200 is displaying (6) coupon images, starting with an online coupon 230 and another online coupon 240. The interface 200 also includes coupon category lists 212, 214. A user may select a category list entry, e.g., Groceries, to display the available coupons in that category. The displayed coupons may then be added to the user's list of clipped coupons by, for example, selecting the clip button, such as the button 238. A physical coupon category list 212 lists categories of coupons that are available on the web site presently being viewed. The list 212 also lists coupons that are new (e.g., arrived in the past day, past week, and so on), or will expire soon (e.g., in the next day or week). These physical coupons are, for example, generated by printing out online coupons 230, 240. An online coupon list 214 lists coupons that are online and need not be printed out. This type of online coupon may be used for mail order purchases from online vendors, or other online purchases. In one example, the online coupon list 214 is provided by a shopping web site.

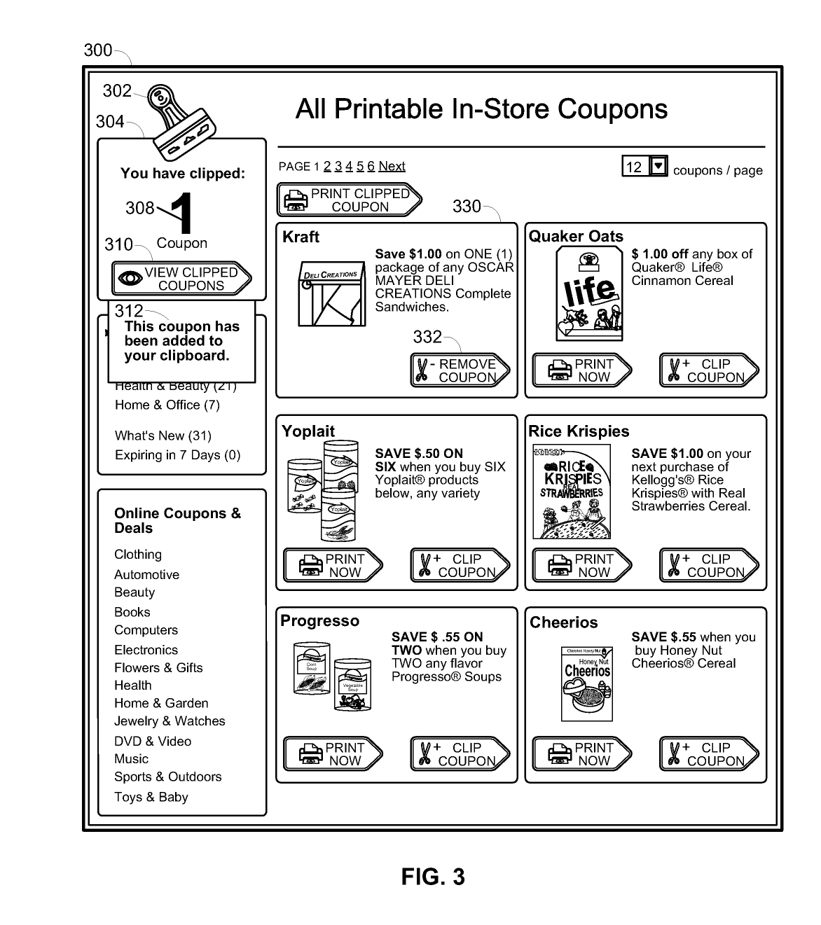

FIG. 3 illustrates a coupon clipping interface in accordance with embodiments of the invention. In FIG. 3, a coupon 330 has been clipped from the list of printable in-store coupons displayed in the interface 300. The coupon 330 has been added to the user's list of clipped coupons, as indicated by the text 312 (“This coupon has been added to your clipboard.”). The number of clipped coupons 308 has increased from 0 to 1, and a Remove Coupon button 332 has replaced the Print Now and Clip Coupon buttons for the clipped coupon 330. The user may select or press the Remove Coupon button 332 to remove the coupon from the list of clipped coupons associated with the user.

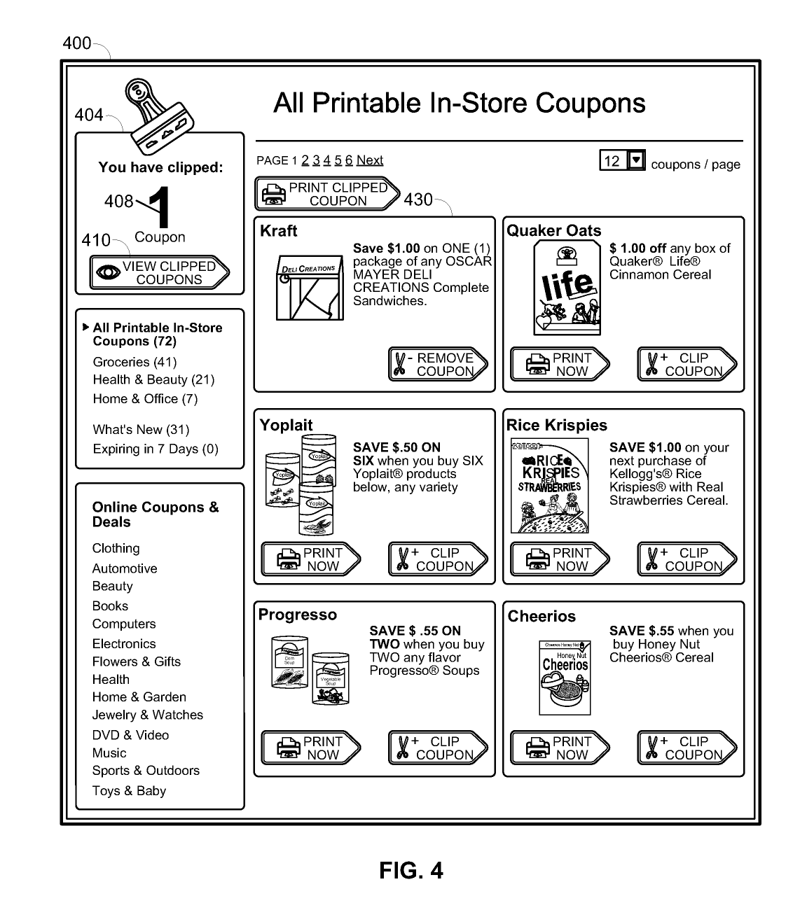

FIG. 4 illustrates the appearance of a coupon clipping interface subsequent to the clipping of the coupon 430. The text 312 shown in FIG. 3 has disappeared, and the clipped coupon count 408 is 1. As in FIGS. 1-3, a user may select the View Clipped Coupons button 410 to display a clipped coupons interface that lists the coupons in the user's clipped coupon list.

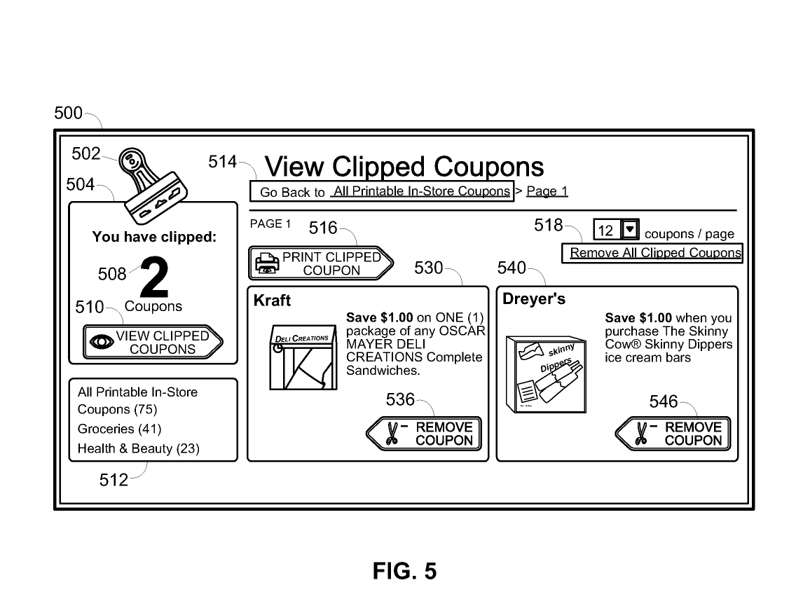

FIG. 5 illustrates a clipped coupon interface in accordance with embodiments of the invention. In one example, the clipped coupon interface 500 appears in response to a user selecting a View Clipped Coupons button, such as the button 310 of FIG. 3. In other examples, the clipped coupon interface 500 appears in response to a user selecting a different interface feature, such as a button or link to a coupon clipper provider's web site. The clipped coupon interface 500 includes features similar to those shown in FIGS. 1-4, including a clip icon 502, a clipped coupon summary 504, a View Clipped Coupons button 510, and a list of categories 512, which lists categories of printable coupons in this example. The clipped coupon interface 500 also includes a link 514 back to the coupon clipping interface, which causes the coupon clipping interface of FIGS. 1-4 to be displayed, e.g., in place of the clipped coupon interface 500. The clipped coupon interface 500 also includes a Print Clipped Coupon button 516, which, if selected or pressed by the user, causes one or more clipped coupons 530, 540 (i.e., coupons in the user's clipped coupons list) to be printed. Each coupon 530 includes a vendor name, an image, a description, and a Remove Coupon button 536. A Remove All Clipped Coupons button 518 causes the clipped coupons to be removed from the user's list of clipped coupons, and from the display of the interface 500. In one example, the Remove All Clipped Coupons button 518 removes all clipped coupons from the user's list of clipped coupons.

FIG. 6 illustrates a system for clipping online coupons in accordance with embodiments of the invention. The system 600 includes a client computer 660, which may be, for example, a desktop computer, a laptop computer, a mobile phone, or the like, that communicates with a server computer 662 via a network, such as the Internet. The server computer 662 includes a coupon database 610 of online coupons, which may be provided, for example, by a shopping web site or other electronic commerce system, coupon clipping interface logic 612, which generates a coupon clipping interface 606 for display on a display device 605 (e.g., a computer monitor or mobile device screen) of the client computer 660. The client computer 660 receives user input via an input device 602, e.g., a keyboard, mouse, or the like. The coupon clipping interface logic 612 retrieves online coupons from the database 610, displays the coupons in the coupon clipping interface 606 as described herein with respect to FIGS. 1-4, and receives user input such as commands to print coupons and commands to clip coupons. The coupon clipping interface logic 612 adds each successfully clipped valid coupon to a clipped coupon list 614 via clipped coupon storage and retrieval logic 613. The clipped coupon list 614 may be, for example, an in-memory lookup table, a database table stored on persistent storage such as a disk, an array or list in memory, or any other form of data storage that stores coupon identifiers, e.g., numeric values that correspond to the clipped coupons. The clipped coupon interface logic 616 causes the list of clipped coupons 614 to be displayed by the clipped coupons interface 608 as described herein with respect to FIG. 5, and receives user input such as commands to print coupons and remove coupons from the list of clipped coupons 614. Clipped coupon provider logic 618 makes the clipped coupon list 614 available to external entities such as a printer 620 (for printing coupons) or an online vendor 630 (for redeeming coupons online). The provider logic 618 may communicate with printers 620 via operating system printer programming interfaces, and may communicate with online vendors 630 via, for example, a web service protocol such as the Simple Object Access Protocol (SOAP) or a vendor-specific network-based interface protocol.

The coupon clipping interface logic 612 and the clipped coupon interface logic 616 make the coupon clipping interface 606 and the clipped coupons interface 608, respectively, available to web sites by providing a code, such as a web link (e.g., Uniform Resource Locator) that refers to a snipped of code (e.g., Flash® code as described above). A web site provider may add the coupon clipping interface 606 and/or the clipped coupons interface 608 to web pages of their web site by embedding the web link in the web pages. The logic elements of the system 660 may be implemented by, for example, computer program code.

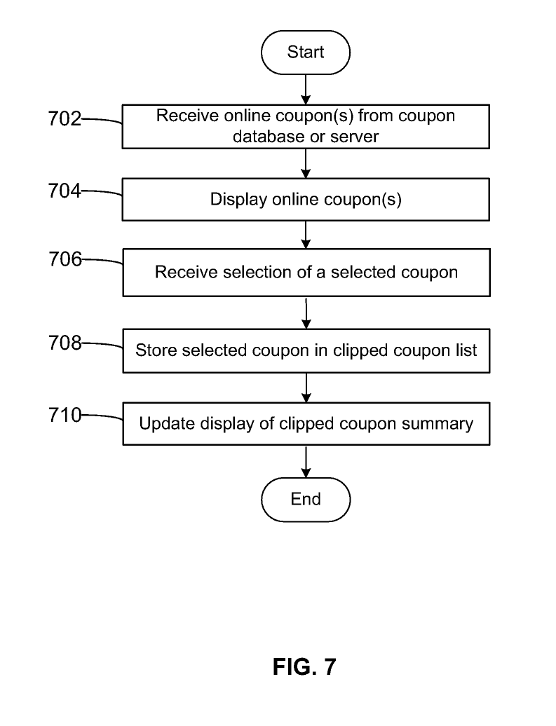

FIG. 7 illustrates a process of clipping online coupons in accordance with embodiments of the invention. Block 702 of the process receives one or more online coupons from a coupon database or a web service (e.g., a server that provides coupons). Block 704 displays the online coupon(s). Block 706 receives selection of a selected coupon, e.g., from a user via a mouse click. Block 708 stores, i.e., saves, the selected coupon in the clipped coupon list. The coupon is represented by, for example, a numeric identifier, which is the value saved in the list. Block 710 updates the display of the clipped coupon summary, e.g., by incrementing the coupon count to include the number of coupons stored in block 708.

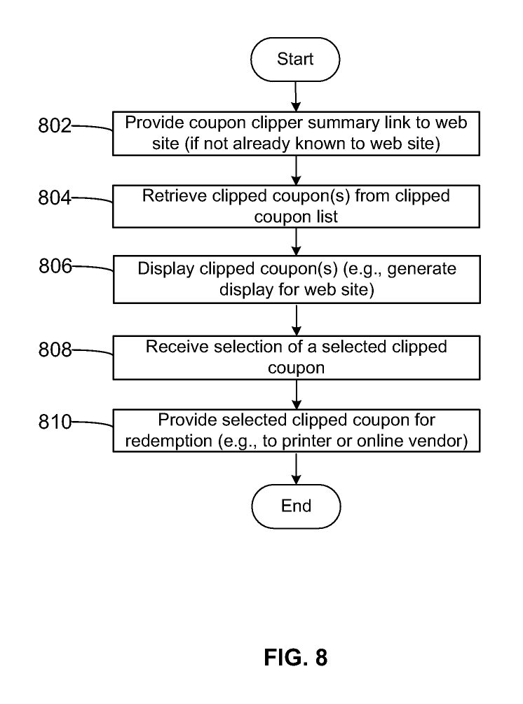

FIG. 8 illustrates a process of displaying clipped coupons in accordance with embodiments of the invention. If the coupon clipper is to be displayed on an “external” web site, i.e., a web site hosted by a different company than the coupon clipper, then block 802 provides a coupon clipper summary link to the web site if the summary link is not already known to the web site. Block 804 retrieves the identifier(s) of the clipped coupon(s) that are in the clipped coupon list. Block 806 displays the clipped coupon(s) by, for example, generating HTML code to be displayed on a web site and sending (i.e., making available) the HTML code to the web site's web server. Block 808 receives selection of a selected clipped coupon, i.e., one of the coupons displayed in block 806. Block 810 provides the selected clipped coupon for redemption, e.g., by sending the selected clipped coupon to a printer or to an online vendor for use in a purchase transaction.

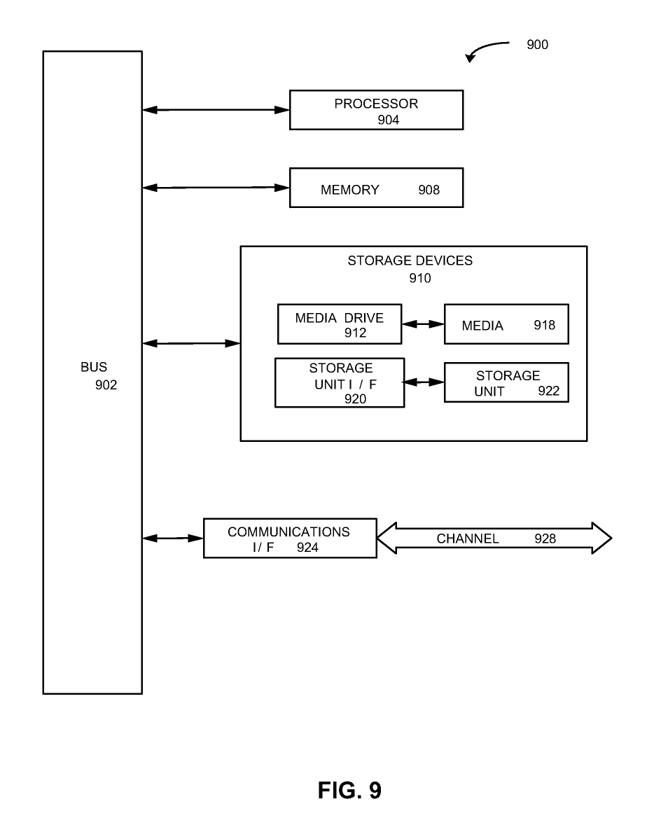

FIG. 9 illustrates a typical computing system 900 that may be employed to implement processing functionality in embodiments of the invention. Computing systems of this type may be used in clients and servers, for example. Those skilled in the relevant art will also recognize how to implement the invention using other computer systems or architectures. Computing system 900 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 900 can include one or more processors, such as a processor 904. Processor 904 can be implemented using a general or special purpose processing engine such as, for example, a microprocessor, microcontroller or other control logic. In this example, processor 904 is connected to a bus 902 or other communication medium.

Computing system 900 can also include a main memory 908, such as random access memory (RAM) or other dynamic memory, for storing information and instructions to be executed by processor 904. Main memory 908 also may be used for storing temporary variables or other intermediate information during execution of instructions to be executed by processor 904. Computing system 900 may likewise include a read only memory (“ROM”) or other static storage device coupled to bus 902 for storing static information and instructions for processor 904.

The computing system 900 may also include information storage system 910, which may include, for example, a media drive 912 and a removable storage interface 920. The media drive 912 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 918, may include, for example, a hard disk, floppy disk, magnetic tape, optical disk, CD or DVD, or other fixed or removable medium that is read by and written to by media drive 914. As these examples illustrate, the storage media 918 may include a computer-readable storage medium having stored therein particular computer software or data.

In alternative embodiments, information storage system 910 may include other similar components for allowing computer programs or other instructions or data to be loaded into computing system 900. Such components may include, for example, a removable storage unit 922 and an interface 920, such as a program cartridge and cartridge interface, a removable memory (for example, a flash memory or other removable memory module) and memory slot, and other removable storage units 922 and interfaces 920 that allow software and data to be transferred from the removable storage unit 918 to computing system 900.

Computing system 900 can also include a communications interface 924. Communications interface 924 can be used to allow software and data to be transferred between computing system 900 and external devices. Examples of communications interface 924 can include a modem, a network interface (such as an Ethernet or other NIC card), a communications port (such as for example, a USB port), a PCMCIA slot and card, etc. Software and data transferred via communications interface 924 are in the form of signals which can be electronic, electromagnetic, optical or other signals capable of being received by communications interface 924. These signals are provided to communications interface 924 via a channel 928. This channel 928 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 908, storage device 918, or storage unit 922. These and other forms of computer-readable media may be involved in storing one or more instructions for use by processor 904, to cause the processor to perform specified operations. Such instructions, generally referred to as “computer program code” (which may be grouped in the form of computer programs or other groupings), when executed, enable the computing system 900 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 900 using, for example, removable storage drive 914, drive 912 or communications interface 924. The control logic (in this example, software instructions or computer program code), when executed by the processor 904, causes the processor 904 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

Although only certain exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. Coupon clipping apparatus comprising:
coupon clipping interface logic operable to display at least one online coupon, and to receive selection of at least one selected coupon selected from the at least one online coupon;
coupon provider logic operable to provide the at least one selected coupon for subsequent redemption in response to user selection of a redemption user interface feature associated with the at least one selected coupon;
clipped coupon storage logic operable to store the at least one selected coupon as at least one clipped coupon in response to user selection of a clip coupon interface component associated with the at least one selected coupon, wherein the at least one clipped coupon is available for subsequent retrieval via a clipped coupons interface, and
the coupon clipping interface logic further operable to display a summary representation of the at least one clipped coupon.

2. The apparatus of claim 1, wherein the coupon provider logic is further operable to print a physical representation of the online coupon.

3. The apparatus of claim 1, wherein the coupon provider logic is further operable to transmit a representation of the at least one selected coupon to an online vendor via a computer network.

4. The apparatus of claim 1, further comprising:
clipped coupon interface logic operable to display the at least one clipped coupon in response to receiving selection of an interface feature associated with the summary representation of the at least one clipped coupon; and
clipped coupon provider logic operable to provide the at least one clipped coupon for subsequent redemption in response to user selection of a redemption user interface feature.

5. The apparatus of claim 4, wherein the clipped coupon interface logic is further operable to remove a selected coupon from the at least one clipped coupon in response to receiving selection of a remove interface feature.

6. The apparatus of claim 5, wherein the remove interface feature is associated with the at least one clipped coupon.

7. The apparatus of claim 4, wherein the clipped coupon provider logic is further operable to print a physical representation of the at least one clipped coupon.

8. The apparatus of claim 4, wherein the clipped coupon provider logic is further operable to transmit a representation of the at least one clipped coupon to an online vendor via a computer network.

9. The apparatus of claim 4, wherein the clipped coupon interface logic is operable to display the at least one online coupon in response to selection of a return to coupons user interface feature.

10. The apparatus of claim 4, wherein the at least one clipped coupon is associated with a user.

11. The apparatus of claim 4, wherein clipped coupon interface logic operable to display the at least one clipped coupon on a web page.

12. The apparatus of claim 11 wherein the user comprises a user logged into a web site that displays the web page.

13. The apparatus of claim 1, wherein the coupon clipping interface logic is operable to display a selected number of coupons per page.

14. The apparatus of claim 13, wherein the coupon clipping interface is operable to change the number of coupons displayed per page in response to user selection of a coupons per page interface feature.

15. The apparatus of claim 1, wherein the coupon clipping interface logic is operable to display at least one categorized coupon in response to user selection of a category user interface feature.

16. The apparatus of claim 1, wherein the coupon clipping interface logic is operable to display at least one filtered coupon, wherein the at least one filtered coupon is selected from the at least one online coupon based upon a filter in response to selection of the filter.

17. The apparatus of claim 1, wherein the coupon clipping interface logic is operable to display at least one new coupon in response to user selection of a view new coupons user interface feature.

18. The apparatus of claim 1, wherein the coupon clipping interface logic is operable to display at least one expiring coupon in response to user selection of an expiring user interface feature.

19. The apparatus of claim 1, wherein the coupon clipping interface logic is operable to display at least one advertisement, wherein the at least one advertisement is related to the at least one online coupon.

20. The apparatus of claim 1 further comprising:
search interface logic operable to search the at least one online coupon and display at least one matching online coupon in response to receiving a search string from a user, wherein the at least one matching coupon matches the search string.

21. A coupon clipper apparatus comprising:
clipping interface linking logic operable to provide a link to a clipped coupon interface page;
clipped coupon retrieval logic operable to retrieve at least one clipped coupon from a clipped coupon list in response to receiving selection of the coupon clipper link;
clipped coupon interface logic operable to cause display of a summary representation of the at least one clipped coupon, and to cause display of the at least one clipped coupon in response to receiving selection of an interface component associated with the summary representation; and
clipped coupon provider logic operable to provide the at least one clipped coupon for subsequent redemption in response to user selection of a redemption user interface feature.

22. The apparatus of claim 21, wherein the clipped coupon interface logic is further operable to remove a selected coupon from the at least one clipped coupon in response to receiving selection of a remove interface feature.

23. The apparatus of claim 21, wherein the remove interface feature is associated with the at least one clipped coupon.

24. The apparatus of claim 21, wherein the clipped coupon provider logic is further operable to print a physical representation of the at least one clipped coupon.

25. The apparatus of claim 21, wherein the clipped coupon provider logic is further operable to transmit a representation of the at least one clipped coupon to an online vendor via a computer network.

26. A coupon clipping interface comprising:
a coupon clipping component operable to display at least one online coupon, and to receive selection of at least one selected coupon selected from the at least one online coupon;
a coupon provider component operable to provide the at least one selected coupon for subsequent redemption in response to user selection of a redemption user interface feature associated with the at least one selected coupon;
a clipped coupon storage component operable to store the at least one selected coupon as at least one clipped coupon in response to user selection of a clip coupon interface component associated with the at least one selected coupon, wherein the at least one clipped coupon is available for subsequent retrieval via a clipped coupons interface, and
the coupon clipping interface component further operable to display a summary representation of the at least one clipped coupon.

27. The interface of claim 26, further comprising:
a clipped coupon interface component operable to display the at least one clipped coupon in response to receiving selection of an interface feature associated with the summary representation of the at least one clipped coupon; and
a clipped coupon provider component operable to provide the at least one clipped coupon for subsequent redemption in response to user selection of a redemption user interface feature.

28. A computer-enabled method of coupon clipping, the method comprising:
displaying at least one online coupon, and to receive selection of at least one selected coupon selected from the at least one online coupon;
providing the at least one selected coupon for subsequent redemption in response to user selection of a redemption user interface feature associated with the at least one selected coupon;
storing the at least one selected coupon as at least one clipped coupon in response to user selection of a clip coupon interface component associated with the at least one selected coupon, wherein the at least one clipped coupon is available for subsequent retrieval via a clipped coupons interface component, and
displaying a summary representation of the at least one clipped coupon.

29. The method of claim 28, further comprising:
displaying the at least one clipped coupon in response to receiving selection of an interface feature associated with the summary representation of the at least one clipped coupon; and
providing the at least one clipped coupon for subsequent redemption in response to user selection of a redemption user interface feature.

30. A computer program product comprising program code for coupon clipping, the computer program product comprising program code for:
displaying at least one online coupon;
receiving selection of at least one selected coupon selected from the at least one online coupon;
providing the at least one selected coupon for subsequent redemption in response to user selection of a redemption user interface feature associated with the at least one selected coupon;
storing the at least one selected coupon as at least one clipped coupon in response to user selection of a clip coupon interface component associated with the at least one selected coupon, wherein the at least one clipped coupon is available for subsequent retrieval via a clipped coupons interface, and
displaying a summary representation of the at least one clipped coupon.

31. The computer program product of claim 30, further comprising program code for:
displaying the at least one clipped coupon in response to receiving selection of an interface feature associated with the summary representation of the at least one clipped coupon; and
providing the at least one clipped coupon for subsequent redemption in response to user selection of a redemption user interface feature.
